(19) United States
(12) Patent Application Publication
(10) Pub. No.: US 2013/0282571 A1
(43) Pub. Date: Oct. 24, 2013

(54) System and method for dynamic contact management

(71) Applicant: Black Hills IP Holdings, LLC, (US)

(72) Inventor: Steven W. Lundberg, Edina, MN (US)

(73) Assignee: Black Hills IP Holdings, LLC, Minneapolis, MN (US)

(21) Appl. No.: 13/573,803

(22) Filed: Oct. 3, 2012

Related U.S. Application Data
(60) Provisional application No. 61/542,515, filed on Oct. 3, 2011.
(60) Provisional application No. 61/561,502, filed on Nov. 18, 2011.
(60) Provisional application No. 61/691,182, filed on Aug. 20, 2012.

(51) Int. Cl. G06Q 50/18; G06Q 30/04

(52) U.S. Cl. CPC G06Q 50/184; G06Q 30/04
USPC 705/40

(57) ABSTRACT

A system for dynamic contact management may include storing in a database, a patent entry that includes data fields for a payment due date and a payment amount associated with a fee due; associating a primary contact and at least one secondary contact with the patent; receiving contact information for the primary contact and contact information for the at least one secondary contact; determining if the primary contact is available by periodically contacting the primary contact using the contact information for the primary contact before the payment due date; and when it is determined the primary contact is not available: contacting a secondary contact of the at least one secondary contact to retrieve updated contact information for the primary contact; and when it is determined the primary contact is available: storing an indication in the database that the contact information for the primary contact is up-to-date.

### CLAIMS OF PRIORITY

This patent application claims the benefit of priority, under 35 U.S.C. Section 119(e), to Lundberg et al, U.S. Provisional Patent Application Ser. No. 61/542,515, entitled “System and Method for Patent Portfolio Management” filed on Oct. 3, 2011 which is hereby incorporated by reference herein in its entirety.

This patent application also claims the benefit of priority, under 35 U.S.C. Section 119(e), to Lundberg et al, U.S. Provisional Patent Application Ser. No. 61/561,502, entitled “Systems, Methods And User Interfaces In A Patent Management System” filed on Nov. 18, 2011, which is hereby incorporated by reference herein in its entirety.

This patent application also claims the benefit of priority, under 35 U.S.C. Section 119(e), to Lundberg et al, U.S. Provisional Patent Application Ser. No. 61/691,182, entitled “System And Method For Patent Portfolio Management” filed on Aug. 20, 2012, which is hereby incorporated by reference herein in its entirety.

### BACKGROUND

The management of a patent portfolio involves multiple stages. Initially, a decision must be made as to what inventions are worth the investment of filing a patent application. Then, each filed patent application goes through prosecution with the patent office. Finally, for each patent that is allowed, maintenance fees must be paid at a variety of intervals to keep the patent in force.

### BRIEF DESCRIPTION OF DRAWINGS

Some embodiments are illustrated by way of example and not limitation in the figures of the accompanying drawings in which:

FIG. 1 is a schematic view of computer network system 100 according to an example various embodiment.

FIG. 2 is an example user interface, according to an example embodiment.

FIG. 3 is an block diagram of an annuity management system, according to an example embodiment.

FIGS. 4-5 are example user interfaces, according to various example embodiments.

FIG. 6 is a flowchart illustrating a method of determining the availability of a contact, according to an example embodiment.

FIGS. 7-10 are example user interfaces, according to various example embodiments.

FIG. 11 is a block diagram of machine in the example form of a computer system within which a set instructions, for causing the machine to perform any one or more of the methodologies discussed herein, may be executed.

### DETAILED DESCRIPTION

The management of a patent portfolio involves multiple stages. Initially, a decision must be made as to what inventions are worth the investment of filing a patent application. Then, each filed patent application goes through prosecution with the patent office. Finally, for each patent that is allowed, maintenance fees must be paid at a variety of intervals to keep the patent in force. At each stage there are opportunities to stop spending the time and resources to obtain and maintain a patent.

In order to make knowledgeable choices the manager of the portfolio may want to know a variety of information. For example, before paying maintenance fees of an issued patent, a manager may want to know the estimated cost of the annuities over the life of the patent, whether the patent covers any current products of a company, whether the patent covers competitors patents, whether the patent is related to a licensing agreement, how influential a patent is, and what companies have been patenting recently. Additionally, it may be important to have up-to-date contact information for an entity responsible for paying the annuity. In various embodiments, an annuity management system provides tools to facilitate the manager's decisions with respect to patent portfolio management as well as keeping contact information up-to-date.

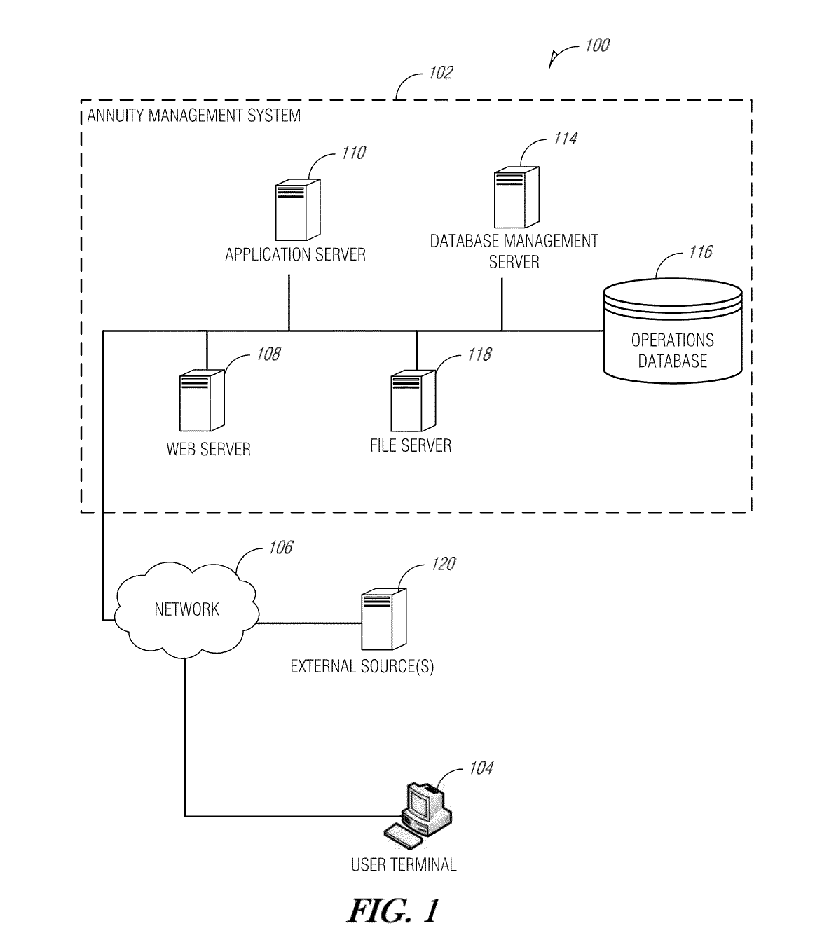

FIG. 1 is a schematic view of computer network system 100 according to various embodiments. The computer network system 100 includes annuity management system 102 and user terminal 104, communicatively coupled via network 106. In an embodiment, annuity management system 102 includes web server 108, application server 110, database management server 114, which is used to manage at least operations database 116, and file server 118. Annuity management system 102 may be implemented as a distributed system, for example one or more elements of the annuity management system 102 may be located across a wide-area network from other elements of annuity management system 102. As another example, a server (e.g., web server 108, file server 118, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based presentation of information. For example, application server 110 may consist of scripts, applications, or library files that provide primary or auxiliary functionality to web server 108 (e.g., multimedia, file transfer, or dynamic interface functions). In addition, application server 110 may also provide some or the entire interface for web server 108 to communicate with one or more of the other servers in the annuity management system 102 (e.g., database management server 114). Web server 108, either alone or in conjunction with one or more other computers in annuity management system 102, may provide a user-interface. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™M, JFC (Java™Foundation Classes), and Swing (an Application Programming Interface for Java™).

User terminal 104 may be a personal computer or mobile device. In an embodiment, user terminal 104 includes a client program to interface with annuity management system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a, compilation, represent an “operations database.” Sub-databases in such a configuration may include a matter database, portfolio database, user database, product database, watch database, and mapping database. Operations database 116 may be implemented as a relational database, a centralized database, a distributed database, an object oriented database, or a flat database in various embodiments.

Data stored in a first database may be associated with data in a second database through the use of common data fields. For example, consider entries in the patent database formatted as [Patent ID, Patent Number] and entries in the product database formatted as [Product ID, Product Name, Patent ID]. In this manner, a product entry in the product database is associated with a patent in the patent database through the Patent ID data field. In various embodiments, a product may be associated with more than one patent by creating multiple entries in the product database, one for each patent the product is associated with. The formats and data field titles are for illustration purposes and other names and formats may be used. Additionally, further associations between data stored in the databases may be created as discussed further herein.

During operation of annuity management system 102, data from multiple data sources (internal and external) is imported into the operations database 116. Internal sources may include data from portfolio management and annuity payment services affiliated with annuity management system 102. External sources may include websites or databases associated with foreign and domestic patent offices, assignment databases, WIPO, and INPADOC. In various embodiments, the data is scrapped and parsed from the websites if it is unavailable through a database. The data may be gathered using API calls to the sources when available. The data may be imported and stored in the operations database on a scheduled basis, such as weekly, monthly, quarterly, or some other regular or periodic interval. Alternatively, the data may be imported on-demand.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats).

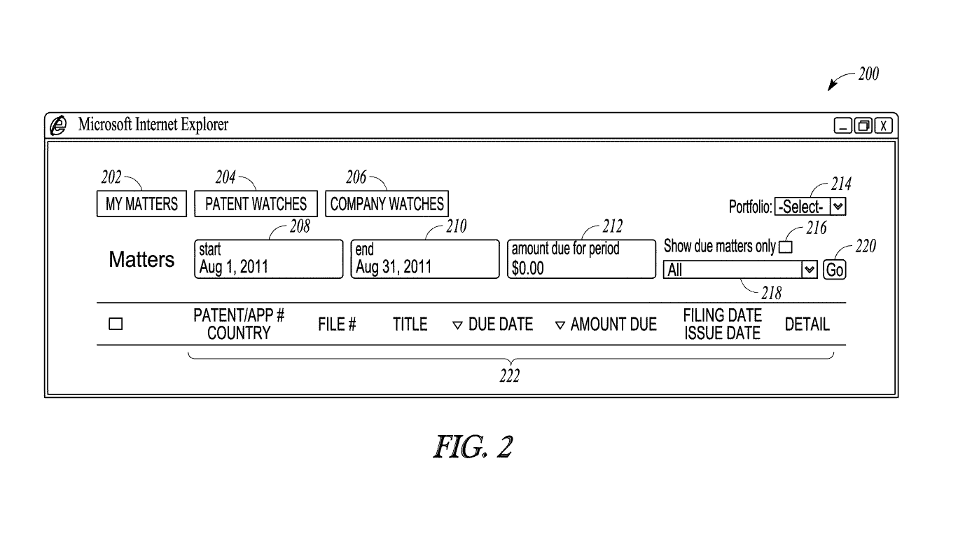

FIG. 2 is an example user interface 200 of annuity management system 102. User interface 200 is illustrated with multiple user interface elements. In an example embodiment, a user interface element is a graphical or textual element that a user may interact with to cause an application to perform an assigned action for the interface element. Data representing user interface 200 may be transmitted via network 106 and presented on a display of user terminal 104 through the use of a web browser. A user (e.g., manager of a patent portfolio) may interact with the user interface elements of user interface 200 through the use of an input device (e.g., stylus, cursor, mouse, finger) of the user terminal. In an embodiment, a user selection is based on the coordinates of the input device as it makes contact with the display or where a user “clicks” the mouse. The coordinates are compared to the coordinates of the user input element to determine the selection. The type of user elements, names, and layout depicted in FIG. 2 are intended to be an illustration of an example user interface of annuity management system 100. Other types of user elements, names, and layouts may be used.

The user interface elements may include my matters 202, patent watches 204, and company watches 206. These elements may be used to select a context/view of the annuity management system. For example, my matters lists the patents included within a portfolio of a user, patent watches lists information on patents that the user has indicated the annuity management system is to watch, and company watches lists information on companies that the user has indicated the system should watch. Further details of each of these included herein.

Date boxes 208 and 210 are user elements that allow a user to select a time period. Amount due box 112 displays the amount due with respect to annuities for patents in the portfolio of the user within the period indicated by date boxes 208 and 210. Upon activating (e.g., clicking) one of the date boxes, a user may be presented with a calendar which allows the selection of a date. Upon selecting a date, the date boxes will update to reflect the user's choice.

Drop-down menu 214 includes a list of portfolios that a user of the annuity management system is authorized to view. For example, before user interface 200 is displayed, a login screen may be presented to the user which requests a user ID and password. In various embodiments, the user ID is associated with one or more portfolios. In turn, each portfolio is associated with one or more matters. Matters may include US and foreign issued patents, pending patents, abandoned patents, and not yet filed applications. Thus, upon selection of a portfolio using drop-down menu 214, user interface 200 is populated with matters associated with the portfolio.

Checkbox 216 is an option to only display matters that currently have an annuity due. Drop-down menu 218 allows further filtering of matters. For example the matters may be filtered by US patents only, US patent applications, and foreign only.

In various embodiments, activation of button 220 updates user interface 200 to reflect the choices made by the user with respect to date boxes 208 and 210, checkbox 216, and drop-down menu 218. For example, amount due box 112 will be updated to reflect the amount due within the new period and the matters listed under column headings 222 may be filtered. In various embodiments, user interface 200 is updated as the user selections are made with respect to elements 208 to 218 without activating button 220.

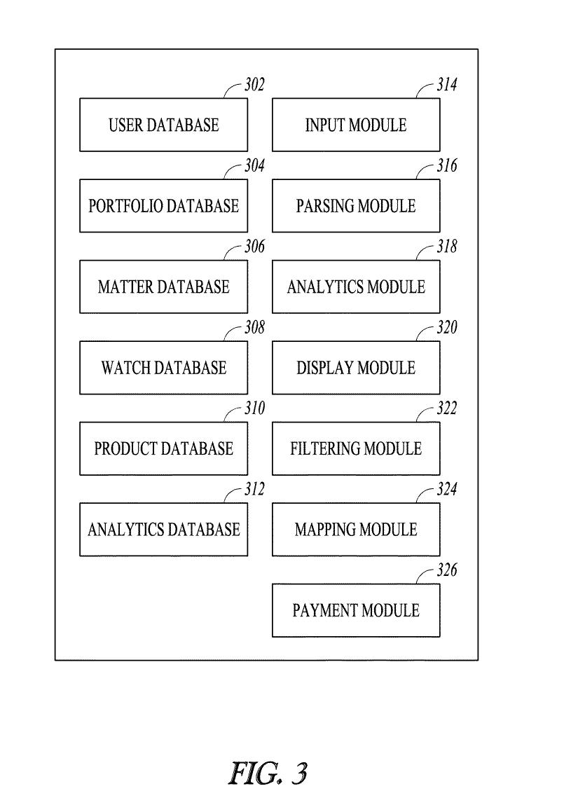

FIG. 3 is an block diagram of annuity management system 102, according to an example embodiment. Illustrated are user database 302, portfolio database 304, matter database 306, watch database 308, product database 310, analytics database 312, input module 314, parsing module 316, analytics module 318, display module 320, filtering module 322, and mapping module 324, and payment module 324. In various embodiments, the data stored in databases 302, 304, 306, 308, and 310 may be in the same or multiple physical locations. For example, portfolio database 304 may be located in one or more computers associated with a portfolio management service. In various embodiments, annuity management system 102 mirrors databases stored in other locations. In an embodiment, when a request is made to access data stored in the databases, annuity management system 102 determines where the data is located and directs the request to the appropriate location.

In an example embodiment user database 302 stores data representing users of annuity management system 102. The data may include data fields of user credentials including a user ID and password and access rights with respect to annuity management system 102. The user ID may be the same as the user ID of other systems associated with annuity management system 102. For example the user ID may be used in a portfolio management system. In this manner, access rights of the user with respect to the portfolio management system may follow to the annuity management system. In various embodiments, each user ID is associated with one or more portfolio IDs. Thus, when a user logs into annuity management system 102, the user is presented with access to only the portfolios that have been associated with the user ID. More or fewer data fields associated with a user may be included in a user entry stored in user database 302.

Portfolio database 304, in an example embodiment, stores data representing portfolios of one or more matters. A matter may include foreign or domestic issued patents in addition to applications. Data stored in portfolio database 304 may initially have been generated in a portfolio management system and imported into annuity management system 102 through the use of one or more API calls or direct access to the data in the portfolio management system. In various embodiments, a portfolio may be generated by user using annuity management system 102. For example, user interface may be presented to the user requesting a name in portfolio and identifiers of matters to be included in the portfolio. In an embodiment, a portfolio entry in portfolio database 304 includes data fields of portfolio ID and portfolio name. Additionally, a data field for matter ID may also be included in an entry in the portfolio database. Thus, each portfolio may be associated with one or more matters through the use of the matter ID data field. More or fewer data fields associated with a portfolio may be included in a portfolio entry of portfolio database 304.

In an embodiment, matter database 306 stores data representing matters. Each matter may be associated with one or more portfolios as well as one or more watches. In some embodiments, a matter is associated with no portfolios or watches. In an embodiment, a matter entry includes data fields representing a matter ID, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, inventors of the matter, current owner of the matter, cited references on the face of the matter, filed date, issue date, docket number, and annuity information (e.g., due date, country, and amount due). More or fewer data fields associated with a patent may be included in a matter entry stored in matter database 306.

In various embodiments, a matter is associated with one or more other matters as a family with a family ID. Family members may be priority documents, continuation patents/applications, divisional patents/applications, and foreign patent/application counterparts. In an embodiment, family information is determined according to an external source such as INPADOC.

In an embodiment, watch database 308 stores data representing user preferences with respect to objects the user wants to track (e.g., watch). In an embodiment, an object is a company or a matter. With respect to matters, a user may indicate a preference to track the matter for any forward citations within a time period (e.g., 60 days, 3 months, etc). Thus, watch database 308 may store entries with a Watch ID that is associated with a User ID and a matter ID. With respect to companies, a user may indicate a preference to watch for publications or issued patents with a timer period. Thus, watch database 308 may store entries with a Watch ID, a user ID, and a company name. In various embodiments, the watches are user ID specific such that no matter what profile the user is viewing, the watches do not change.

In an embodiment, product database 310 stores data representing products. The products may be actual products manufactured by the user, products yet to be released, planned products, products covered in a licensing agreement, or a fictional product. In various embodiments, product database 310 stores entries with a product ID and product name which are associated with a user ID. In various embodiments, a user may tag a product as associated with a matter. Thus, an entry in the product database may also be associated with a matter ID.

In various embodiments, analytics database 312 stores data representing information on matters and companies associated with annuity management system 102. This information may be organized according to an individual matter, a portfolio, a family, or company. The information may be gathered from internal or external sources of annuity management system 102 or may be generated by examining the data stored in one or more databases of annuity management system 102.

In various embodiments, information for an individual matter may include status (e.g., disclosure received, drafting, filed, completed-waiting examination, in prosecution, allowed, issued), cited prior art, list and type of rejections (e.g., 35 U.S.C. §101, 102, 103) number of claims allowed, office action count, interviews held, IDS statements filed, attorney fees to date, and PTO fees to date. Further metrics for an individual matter stored in analytics database 312 may include, time waiting for examiner, total time in examination, time waiting for PTO while in examination, time on appeal. Additional prosecution details formatter may include an upcoming docket dates (e.g., due dates for office action, IDS due dates, etc.). A claim prosecution history chart may also be stored in analytics database 312 for each matter. The prosecution history may include a history of claim amendments and arguments made in prosecution.

In various embodiments, analytics for an individual matter may also include data representing a claim chart. The claim chart may include one or more scope concepts on one axis and claims on the other axis. In an embodiment, a scope concept is a textual description of what a patent claim is at least limited to. Thus, if a claim comprises A, B, & C a scope concept may be A. In various embodiments, a scope concept for the claim may be broader than A because the claim will still be limited to the broader scope concept. In an embodiment, the claim charts stores mappings between claims and scope concepts. The claim chart may include a variety of levels of granularity of scope concepts. Some claims may be mapped to all of the scope concepts while others may not be mapped to any scope concepts. In various embodiments, the mappings have already been generated in a program external to the annuity management system (e.g., a portfolio management system). In various embodiments, claim charts may be combined at the portfolio level. Thus, a portfolio level chart may include scope concepts for all the claims (or in some examples only the independent claims) in the portfolio.

In various embodiments, portfolio and family analytics information may be stored in analytics database 312 based on aggregating the metrics for an individual matter. In an embodiment, the analytics of a family may differ from those in a portfolio as not all family member matters may be part of a portfolio. Additionally, the analytics may be stored for multiple time periods such that comparisons may be made between metrics currently and metrics a year ago (or other time period).

Aggregated metrics may include a total patents and applications, pending and waiting for examination, in prosecution with no claims allowed, in prosecution with some claims allowed, appealed, notice of allowance received, and issued. These metrics may be compiled for both US and international matters in the portfolio. Additional information may include the international portfolio distribution by country. An age distribution of the portfolio may also be compiled. For example the portfolio may be broken down by less than one year old, 1 to 3 years old, 3 to 5 years old, 5 to 10 years old, 10 to 20 years old, and 20 or more years old. Recent filing and issue activity as well as upcoming Ford filing deadlines may be stored in analytics database 312.

In various embodiments, prosecution metrics across a portfolio or family are determined and stored in analytics database 312. This data may include matters waiting for examination, matters in examination, matters appealed, and cases allowed but not yet issued. Analytics with respect office actions may also be compiled and stored. For example success of allowance after a first office action response, a second response, etc., may be stored in analytics database 312. Additional prosecution analytics may include allowance rate (e.g., 10%) after a telephone interview, allowance after an in-person interview, percentage of interviews with response, number and type of rejection, average time in prosecution (e.g., in months), average time to file a response, and average time to next office action. Further, the list of recently allowed cases, recently appeal cases, stalled cases, and recently abandoned cases may also be stored for each portfolio and family in analytics database 312.

In various embodiments, data stored in the database for group of matters in a portfolio or family is analyzed to determine the top (e.g., ten) most cited patents, the top most cited inventors, top most cited prior art owners (e.g., according to assignment documents or the face of the patent), newly (e.g., within the last 60 days) cited prior art owners, and top most cited prior art inventors. This information may be stored in analytics database 312.

In various embodiments, annuity cost information regarding cost projections for both US issued patents and international patents may also be stored. Upcoming foreign filing deadlines with respect to annuities may also be stored in analytics database 312.

In various embodiments, input module 314 receives data from multiple sources where it may be further processed by one or more other modules and stored in one or more of databases 302-312. For example, input module 314 may be configured to utilize one or more APIs to data from one or more patent data stores (e.g., public PAIR, private PAIR, INPADOC, foreign patent offices, patent docketing systems, portfolio management systems, etc). The data may include published patent documents, patent applications, office actions or other patent office correspondence, prior art references, claim mappings, dockets dates, and annuity payment data.

In various embodiments, input module 314 is configured to receive input from one or more user interface elements. For example annuity management system 102 may present multiple user interfaces to users. These user interfaces may enable users to input data directly into databases 302-312, instruct the annuity management system to retrieve data from patent data stores, and instruct the annuity management system to perform various operations on the data in databases 302-312.

Additionally, input module 314 may be configured to determine the selection of one or more user interface elements by a user and initiate the action associated with the selected user interface element. For example user interface element may include a drop-down menu to select a portfolio. Input module 314 may be configured to receive a selection of the portfolio and a drop-down menu. Then, input module 314 may pass the selection to one or more other modules for further processing. For example, display module 320 may update the drop-down menu to indicate the selection of a portfolio.

In various embodiments, parsing module 316 takes the data that has initially been inputted by input module 314 and formats it according to the data fields of databases 302-312 as discussed above. For example, consider a patent publication that is been inputted by input module 314. Parsing module 316 may use a combination of automatic image recognition and text analysis to determine the filing date, issue date, title, abstract, and claims of the patent. In some embodiments, parsing module 316 may flag certain pieces of data that had been determined to be potentially inaccurate (e.g., a number could not be read). A user of annuity management system 102 may then examine the flagged data and manually enter in the information.

The resulting data that has been parsed by parsing module 316 may then be entered as an entry in one or more of databases 302-312. This may be accomplished by, for example, formulating an SQL query with the parsed information. In various embodiments parsing module 316 may parse multiple piece of information before generating a database entry. For example, input module 314 may receive a docket number for an issued patent. The docket number may be combined with the information parse from the issued patent to form an entry in matter database 306.

In various embodiments, analytics module 318 is configured to examine and run calculations on the data stored in the databases 302-312 to generate the analytics discussed previously. For example, analytics module 318 may formulate an SQL query that retrieves the number of times that a prior art reference has been cited within a portfolio. This query may be run for each prior art cited within the portfolio to determine a list of the most cited (e.g., the top ten) prior art references with a portfolio. In an embodiment, the queries are formulated and run as requested by a user. In an embodiment, once the analytics information has been determined it is stored within analytics database 312. In various embodiments, queries are formulated and run on a period basis (e.g., nightly) and entries in analytics database 312 may be updated to reflect any changes.

In an embodiment, display module 320 is configured to display user interfaces and information retrieved from one or more databases 302-312. For example display module 320 may generate user interface 200 of FIG. 2. If a user is accessing annuity management system 102 remotely (e.g., through a web browser) display module 320 may be configured to transmit data representing a user-interface through a network to a user terminal. In various embodiments, display module 320 is configured to generate one or more charts of data stored in databases 302-312. For example, display module 320 may generate a pie chart of the top 10 inventors within a portfolio.

In various embodiments, filtering module 322 is configured to filter a set of matters according to a user preference. For example, a user may activate a check box that indicates only pending matters should be shown in a user interface. Filtering module 322 may formulate a query consistent with retrieving only pending matters. The results of the query may then be shared with display module 320 where the user interface may be updated.

In various embodiments, mapping module 324 is configured to receive mappings from a product to a matter. This may be accomplished, for example, by receiving a selection of a product by user and a matter by the user. In various embodiments, mapping module 324 is configured to present an automated mapping of the product to a matter for user to confirm or deny. For example, mapping module 324 may present a claim chart for an issued patent to a user. As discussed, the claim chart includes one or more scope concepts that one or more the claims of the patent are limited to. In conjunction with input module 314, mapping module 324, may receive selections of the user of one or more of the scope concepts that are potentially affiliated with the product. Thus, a comparison may be made between what the claims are limited to and what the product may be. For example, if a product, as defined by the selection of one or more scope concepts by the user, is affiliated toward scope concepts A, B, and C and claim 1 of the patent has been mapped to scope concepts A, B, and C, the mapping module 324 may present an option to map the product to the patent. In various embodiments the user may override this recommendation and select to not map the product to the patent. Similarly, a user may indicate that a product is affiliated with the patent even if the scope concepts do not match.

In various embodiments, payment module 326 is configured to receive selections by the user of which annuities to pay for matters in a portfolio. Additionally, payment module 326 may receive user preferences related to the payment of the annuities. Payment module 326 may receive payment information from a user and forward the payment information to the appropriate agency/office. In some embodiments, annuity management system 102 organizes payment of the annuity on behalf of the user and the user pays annuity management system 102.

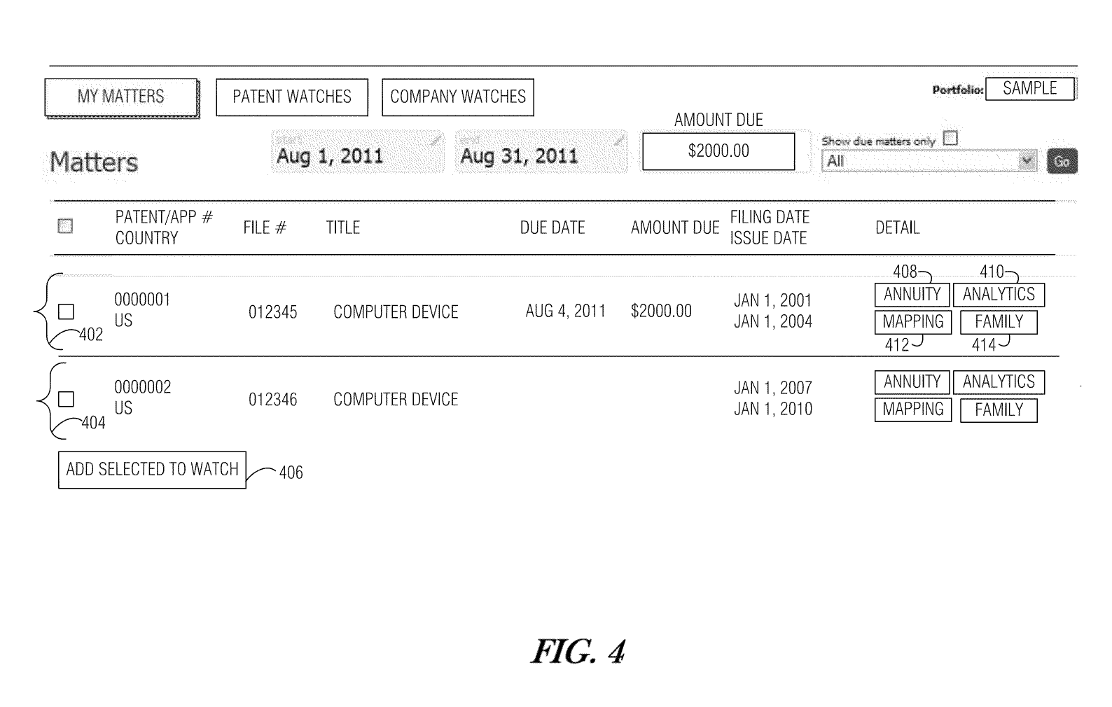

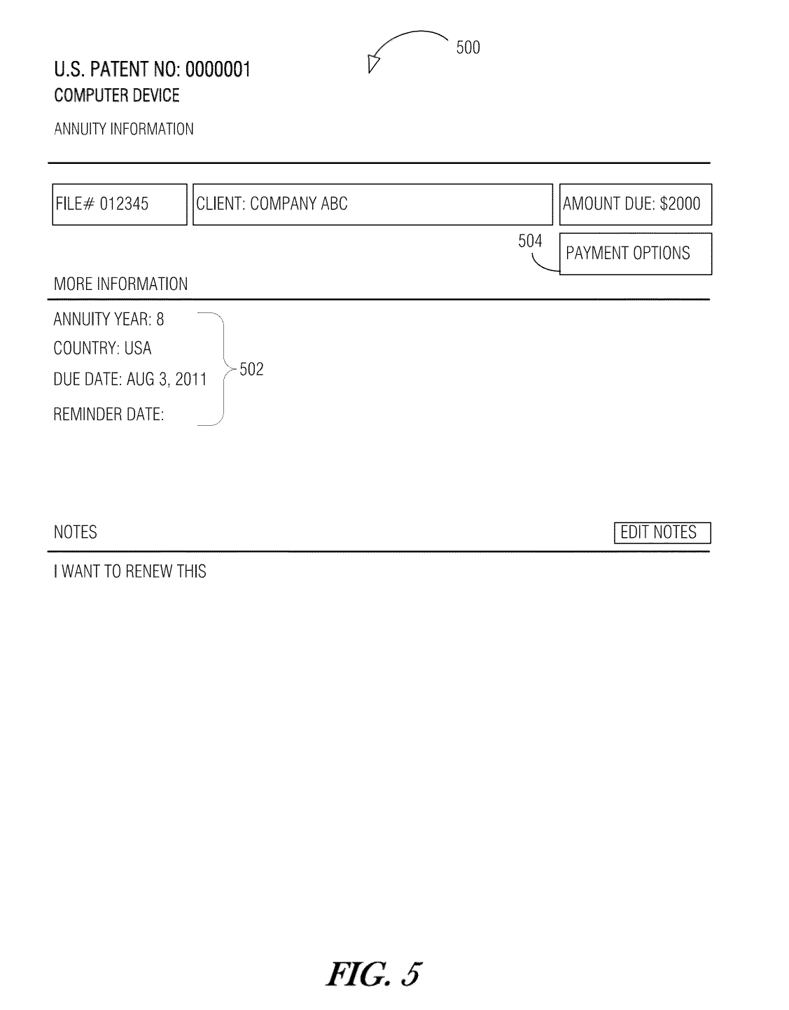

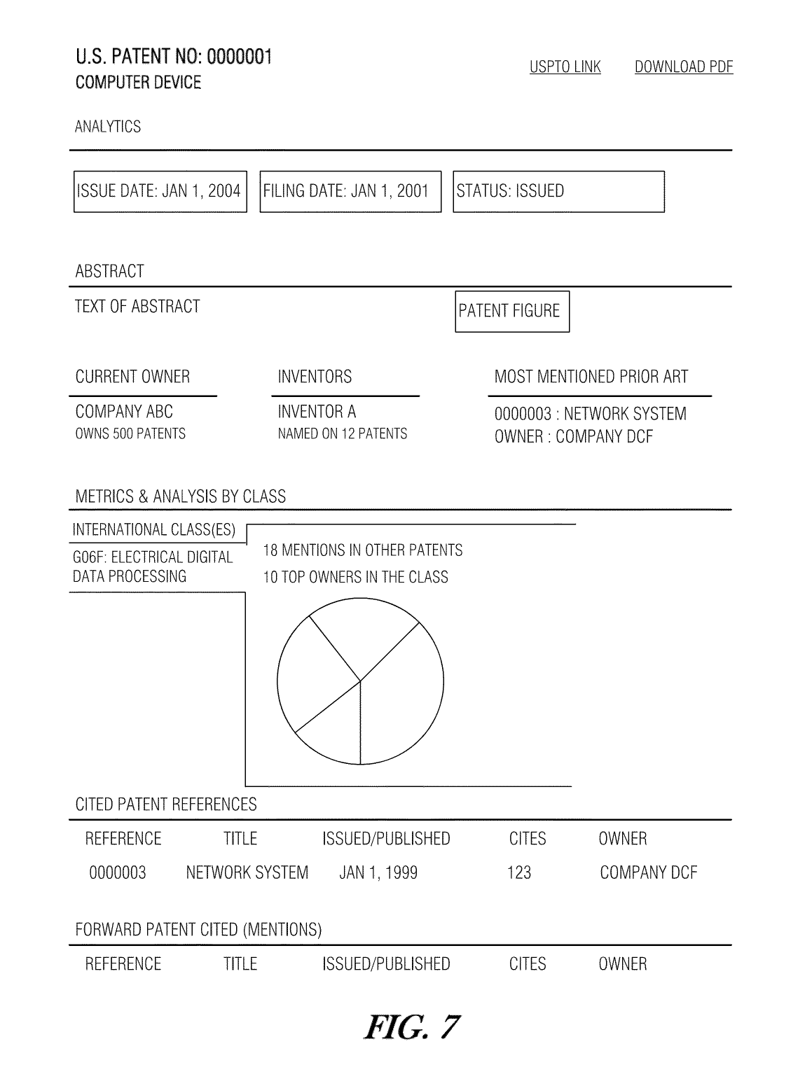

FIG. 4 is an example user interface 400 illustrating an overview of matters 402, 404 in a sample portfolio. The data shown in FIG. 4 may be retrieved from one or more of the database is illustrated in FIG. 3. The data may be displayed using display module 320. As illustrated, the amount due for the portfolio in the selected time period is $2000. In an embodiment, a user may select one of the matters using the checkbox and activate user element 406 to add the selected matter to the patent watches for the user. In response, watch database 308 may be updated to associate the user ID with the matter ID of the selected matters in FIG. 4. A user may see additional details of a matter by activating (e.g., selecting) annuity button 408 (see e.g., FIG. 5), analytics button 410 (see e.g., FIG. 7), mapping button 412, or family button 414.

FIG. 5 is an example user interface 500 illustrating annuity information for a patent. User interface 500 may be displayed by a user selecting annuity button 408. In various embodiments, user interface 500 may displayed to a user in response to receiving a request for annuity information in a system external to annuity management system 102. In other words, the information displayed and discussed with respect to user interface 500 may be used in a docketing or portfolio management system as well. In various embodiments, the data illustrated for a matter is retrieved from one or more databases 302-312 and formatted using display module 320.

Illustrated in FIG. 5 are details for a patent with an annuity due including a patent number, the title of the patent, the docket number, a client name, and the amount due. Additional details 502 concerning the annuity due may include the year of the annuity, the country where the annuity is due, the due date of the annuity, and a possible reminder date for the annuity.

In an embodiment, selection of payment options button 504 begins the process of payment of the annuity. Upon selection of payment options button 504 a user may be presented with multiple options to pay the current annuity. In an embodiment, three basic payment options are presented to a user: (1) pay now based on a current exchange rate between the currency of the paying entity (e.g. the company which owns the patent) and the currency where the annuity is due; (2) pay the annuity on a future date based on a forward contract for currency exchange regardless of the actual exchange rate at the time of payment; and (3) pay the annuity on a future date based on the currency exchange rate at the time of payment. In various embodiments, addition information is provided to the user to help make the decision of how to pay the annuity. This information may include, for example, a trend of the currency exchange rate over a time period.

Owners of patents often have many options of how they wish to pay maintenance fees (annuity fees) on patents they own. For example, there may be other services beyond annuity management system 102 that facilitate payments of maintenance fees. Thus, in various embodiments, annuity management system 102 presents comparison information to the user of the costs of using annuity management system 102 versus other services. The information may include a typical annuity provider fee compared to the cost of annuity management system 102. To further this comparison, an estimate may be calculated for the total projected cost to pay maintenance fees using annuity management system 102 for all of the user's patents in the user's portfolio. This calculated estimate may then be compared to the estimated cost of using other annuity payment services. In an embodiment, an estimated cost is provided based on annuities due for family members of the displayed matter.

In various embodiments, a user interface is provided to allow a user to create an annuity provider charge profile. In an embodiment, an annuity provider charge profile is based on a provider fee (e.g., the cost charged by the service to facilitate the payment), a currency mark-up (e.g., an additional cost for currency exchange), and an agent fee. Thus, annuity management system 102 uses the values entered in the above categories and calculates an estimated cost of paying the annuities based on today's currency conversion rates. In an embodiment, the system may also provide estimated costs based on high and low currency exchange rates over a previous time (e.g., the past six months).

In various embodiments, an administrator of annuity management system 102 sets the fees for using the system to pay the annuities. For example, the administrator may use a user interface provided by the system to set the currency mark-up, an agent fee, and provider fee for user. This information may be stored in one or more databases 302-312. In an embodiment, annuity management system 102 dynamically alters the fees charged to facilitate payment of the annuities based on user specific information. For example, the credit score of the user may be retrieved and, if the user has a poor credit score, annuity management system 102 may increase the provider fee. In an embodiment, the pricing may stay the same but annuity management system 102 may purchase credit insurance for payments made by the user. Beyond the credit score, annuity management system 102 may judge the credit worthiness of a user based on previous payment of fees as well as abandonment of cases.

In an embodiment, annuity management system 102 also provides tracking of patents which require an annuity/maintenance payment. In an embodiment, each patent which requires an annuity/maintenance payment is associated with contact information for the primary party responsible for paying the annuity. A primary contact may be responsible for multiple patents.

Contact information may include information about the contact such a name as well as multiple contact methods such as a physical address, e-mail address, a text message address, a mobile phone number, a landline number, and social network accounts. In an embodiment, the patent is also associated with one or more backup (secondary) contacts with contact information for the backup contacts. The contact information may be stored in one or more databases. The database may also include data fields for a payment due date and a payment amount associated with the fee (e.g., maintenance, annuity, etc.) due. In various embodiments, the contact information and data fields are stored as a patent entry.

Different contact methods may have different mechanisms for contact attempts. For example, for e-mail the system may transmit an e-mail with instructions for the contact to click an embedded link in the e-mail to confirm the contact information is correct. In an embodiment, the system may determine the e-mail is invalid if an error is returned upon sending the e-mail. A contact mechanism for physical addresses may include sending a letter with instructions to dial a number or go to a website to confirm that the contact information is correct.

In an embodiment, the contact information is arranged in a hierarchy such that each contact method is given a priority level. For example, an e-mail address may be given priority level one and physical (e.g., mailing) address may be given priority level two. If the contact information of a contact method is determined to be invalid the next level in the hierarchy may be used. For example, if a bounce-back email is received at the system, a letter may be sent to the physical address stored in the database for the primary contact.

In an embodiment, annuity management system 102 contacts (using one or more of the pieces of contact information) the primary contact periodically (e.g., monthly) to assure that the contact information is still valid. If no reply is received from the primary contact, annuity management system 102 may contact one or more of the backup contacts to determine updated contact information for the primary contact. If the attempt is successful, the patent entries associated with the primary contact be updated to indicate the contact information is current along with the date of contact.

This functionality may be tied to a single patent or group of patents. In situations where a primary contact is listed on multiple patents, annuity management system 102 may only contact the primary contact once and all records in the database associated with the primary contact may be updated as necessary.

In an embodiment, the social network accounts of the contacts may be monitored for activity or deletion of the social network accounts. If annuity management system 102 receives notification that a social network account is no longer valid, an attempt may be made to contact with the user using other contact methods.

In an embodiment, a user of annuity management system 102 may subscribe to a reminder service for one or more of their patents. The reminder service may contact the user using the contact information discussed above. For example, an e-mail may be sent to the user when annuity is coming due (e.g., within the next three months). In an embodiment, the user may set a preference of when reminder should be sent and by which method (e.g., e-mail, phone) the reminder should be sent.

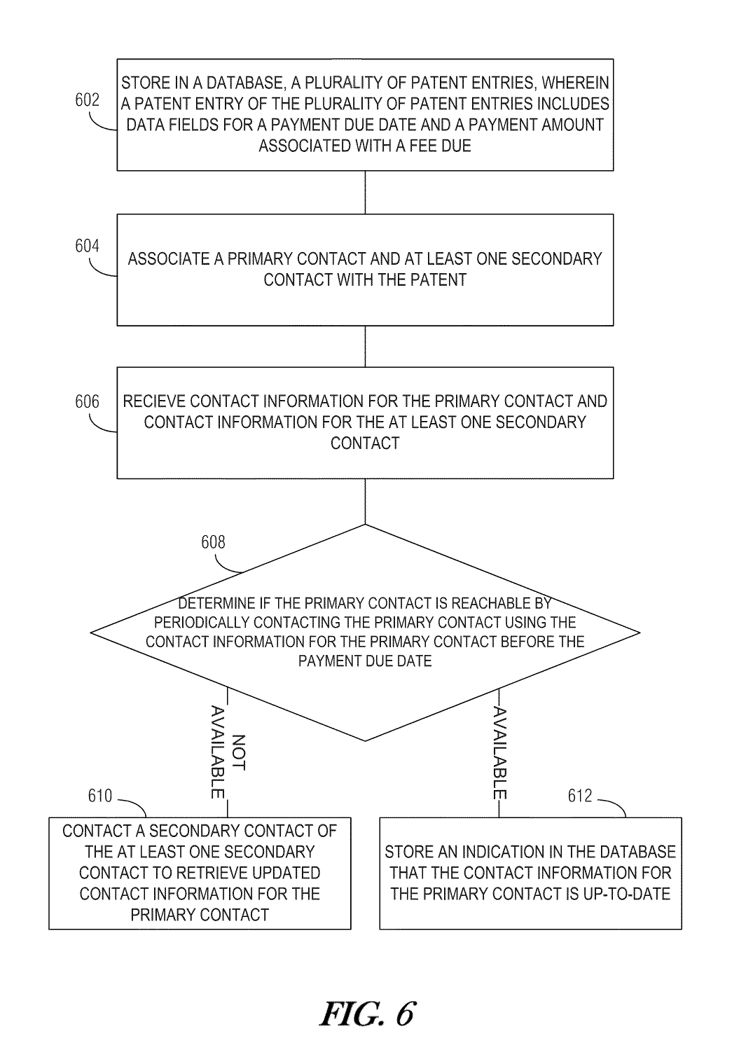

FIG. 6 is a flowchart illustrating an example method of determining the availability of a contact. In an embodiment, at block 602, a plurality of patent entries are stored in a database, wherein a patent entry of the plurality of patent entries includes data fields for a payment due date and a payment amount associated with a fee due. In an embodiment, at block 604, a primary contact and at least one secondary contact are associated with the patent. At block 606, in an embodiment, contact information for the primary contact and contact information for the at least one secondary contact is received.

At decision block 608 it is determined if the primary contact is reachable by periodically contacting the primary contact using the contact information for the primary contact before the payment due date. In an embodiment, if it is determined the primary contact is not available, then at block 610 a secondary contact of the at least one secondary contact is contacted to retrieve updated contact information for the primary contact which may be stored in the database. In an embodiment, if it is determined the primary contact is available, then at block 612 an indication is stored in the database that contact information for the primary contact is up-to-date.

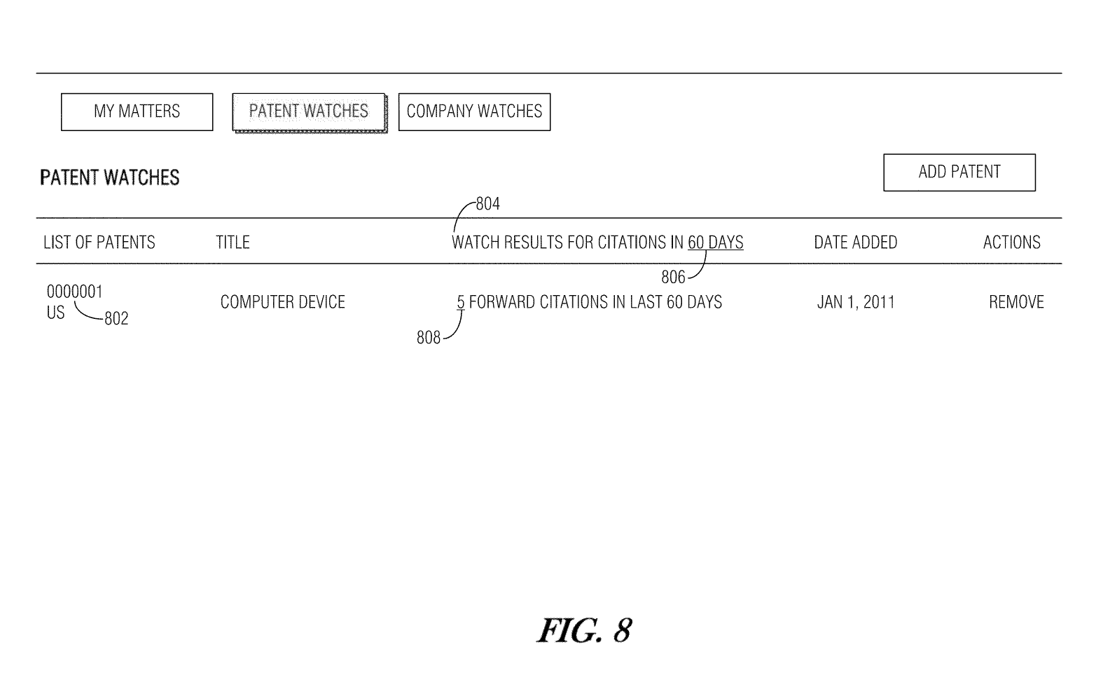

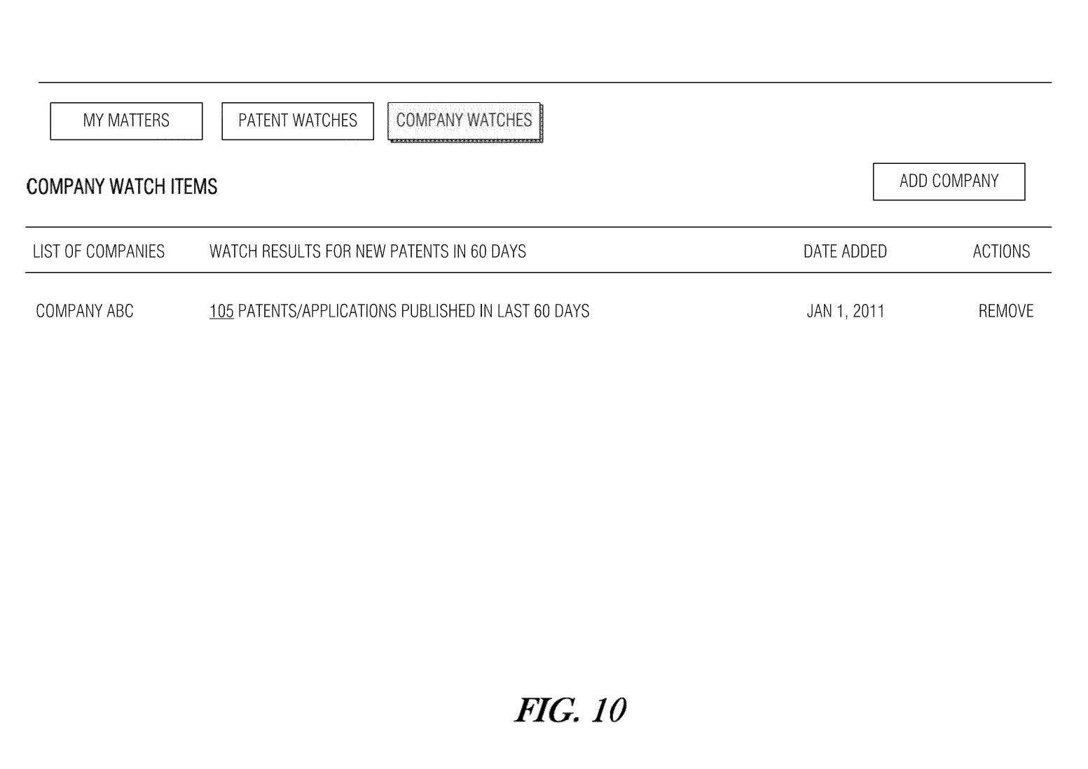

FIG. 8 is a user interface 800 illustrating a watched patent, according to an example embodiment. In various embodiments, patent may be watched for forward citations. A forward citation may be defined in a number of ways: (1) forward citations of prior art; (2) forward citations of applied prior art only; (3) forward citations of the patent being watched; (4) forward citations of forward citations; and (5) forward citations of forward citations of cited art. FIG. 10 illustrates a company watch list user interface, according to an example embodiment.

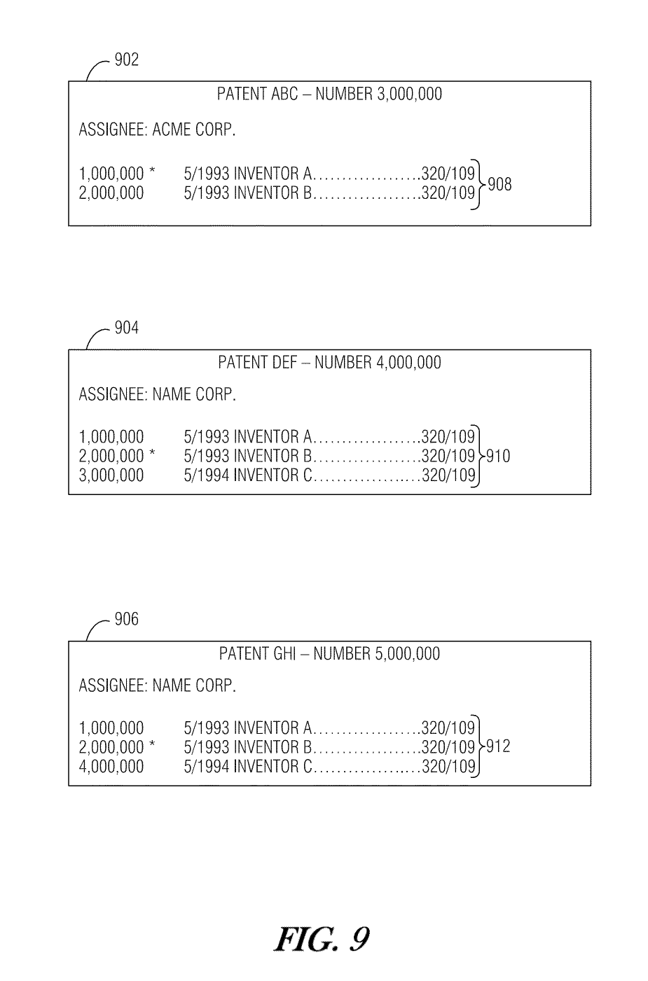

FIG. 9 illustrates example patents 902, 904, and 906 with cited art 908, 910, and 912, respectively. As an introductory example, consider that a user has indicated to the system to watch patent 902. Thus, in a watch database an entry may be generated that associates the ID of the user with an ID of patent 902 (e.g., 3,000,000). In various embodiments, the watch database maintains only one entry per watched patent/application but this entry may be associated with more than one user ID. Within the context of cited art 910, patent numbers 1,000,000 and 2,000,000 are forward citations of prior art of patent 902. Additionally, patent 1,000,000 in cited art 910 is a forward citation of applied prior art as patent 1,000,000 was applied cited art in patent 902. Patent 904 includes a forward citation of patent 902 (sometimes referred to as a direct forward citation) in cited art 910. Within the context of cited art 912, patent number 4,000,000 is a forward citation of a forward citation of 902. Also, within the context of cited art 912, patents 1,000,000 and 2,000,000 are forward citations of forward citations of prior art.

In an embodiment, the system receives an indication that patent DEF has cited patent ABC. Then, the system updates the watch entry for patent ABC. The updated entry may include one or more of the following: a categorization of the forward citation; an identification to the matched published or allowed patent; the date of the published application or issue date of the patent; an identification to the matched piece of prior art; an owner of the application/patent and a link to the matched published or allowed patent. In an embodiment, the categories of forward citations include a forward citation of cited prior art, a forward citation of applied prior art, a direct forward citation, a forward citation of a forward citation, and a forward citation of a forward citation of cited prior art. In an embodiment, an identification includes the publication/patent number. Therefore, if a search of the database is performed for patent DEF, the database may return a result that indicates that patent DEF includes a citation to patent ABC and that the forward citation is a direct citation.

In various embodiments, the link in a watch entry may link to a copy of the published/allowed patent or cited prior art. In various embodiments, the system maintains local copies of the cited prior art for retrieval. Thus, in an embodiment, the link may instruct the system to retrieve the local copy of the cited prior art and transmit it to a user terminal in use by a user. In an embodiment, the link directs a browser of the user terminal to a website outside of the system (e.g., a patent office) for retrieval of the published/allowed patent or cited prior art.

In various embodiments, forward citations of prior art are determined by compiling a list of all prior art listed on patent ABC. This information may be retrieved from one or more databases by submitting a query using the ID of patent ABC. For example, a matter database may maintain a listing of all prior art that has been cited on the face of patent ABC. The prior art may include both patents/applications/non-patent literature that have been cited by the filer of ABC as well as patents/applications/non-patent literature cited by the patent office. In an embodiment, the prior art may be categorized as applied or not applied.

In an embodiment, the list of prior art cited for patent ABC may be determined when the user first indicates the patent is to be watched. For example, annuity management system 102 may request (e.g., via an HTTP request) a copy of patent ABC from one or more websites (e.g., the patent office or third-party patent database) that is analyzed to determine the cited prior art. In various embodiments, a patent is formatted in a consistent manner such that, by using optical character recognition and textual analysis tools, a list of the prior art may be determined. Also, the company that the application/patent is assigned to is often listed on the patent. Thus, optical character recognition and textual analysis tools may determine the owner of the application/patent. In various embodiments, the owning company is verified against assignment records at the patent office. For example the system may electronically submit (e.g., an HTTP request or API call) to retrieve assignment information for the application/patent. In an embodiment, the list and company are checked for accuracy by a human user of the system.

In an embodiment, the system checks published or allowed patents for citations of the compiled list of prior art. The system may use an API to a patent tracking service to retrieve a list of recently (e.g., the past day/week/year) published or allowed patents. In an embodiment, the system may electronically query an official source (e.g., a patent office) for published or allowed patents past a certain date. The system may then analyze the published or allowed patents in a similar manner as patent ABC to determine the cited prior art.

In various embodiments, for each piece of cited prior art on an application/patent that matches a piece of prior art cited on patent ABC, the system updates the watch database entry for patent ABC. The updated entry may include a categorization of the forward citation as a forward citation of prior art, an identification of the matched application/patent, the publication date of the application or issue date of the patent, an identification of the matched prior art, an owner of the application/patent, and a link to the matched application/patent.

In various embodiments, forward citations of applied prior art are determined similarly to forward citations of listed prior art. In an embodiment, the list of prior art of a patent is separated by prior art that has been cited during prosecution and art that has not. For example, if a piece of prior art has been cited during prosecution of the patent, a symbol (e.g., a ‘*’) may be placed next to the prior art such as in the following example list of prior art of patent ABC:

1,000,000 * 5/1993 Inventor A . . . 320/109

2,000,000 5/1993 Inventor B . . . 320/109

As shown, the patent 1,000,000 has been applied during prosecution of patent ABC, but patent 2,000,000 has not. Thus, the system may use textual analysis tools to filter out prior art that has not been applied.

In an embodiment, the system checks published or allowed patents for citations of the compiled list of applied prior art as discussed previously. In various embodiments, for each piece of cited prior art on an application/patent that matches a piece of applied prior art cited on patent ABC, the system updates the watch database entry for patent ABC. The updated entry may include a forward citation categorized as a forward citation of applied prior art, an identification of the matched application/patent, the publication date of the application or issue date of the patent, an owner of the application/patent, and a link to the matched piece of prior art.

In various embodiments, forward citations of the patent ABC are determined. In an embodiment, for each application/patent that cites patent ABC, the system updates the watch database entry for patent ABC. The updated entry may include a forward citation categorized as a direct forward citation, an identification of the matched application/patent, the publication date of the application or issue date of the patent, an identification of the matched prior art, an owner of the application/patent, and a link to application/patent.

In various embodiments, forward citations of forward citations of patent ABC are determined. For example, for each application/patent that matches a forward citation of patent ABC (e.g., is categorized as a direct forward citation of patent ABC), the system updates the watch database entry for patent ABC. The updated entry may include a forward citation categorized as a forward citation of a forward citation, an identification of the matched application/patent, a date of publication of the application or issue date of the patent, an identification of the matched piece of prior art on the matched patent/application, an owner of the application/patent, and a link to the matched application/patent.

In various embodiments, forward citations of forward citations of cited prior art are determined. For example, the system updates the watch database entry for patent ABC when a piece of cited prior art on an application/patent matches a forward citation of a piece of prior art cited on patent ABC. The updated entry may include a forward citation categorized as a forward citation of a forward citation of cited prior art, an identification of the matched application/patent, a date of publication of the application or issue date of the patent, an identification of the matched piece of prior art on the matched patent/application, an owner of the application/patent, and a link to the matched application/patent.

Referring back to FIG. 8, patent 802 is being watched. Illustrated are columns for title, watch results 804, date added, and an option to remove patent from the patent watches for the user. Within FIG. 8, watch results 804 are summarized (e.g., the number of forward citations for the past 60 days). Link 806 may present a user interface to a user allowing the selection of time period and category of forward citation to summarize. Further illustrated is link 808 which, when activated, may direct a web browser of the user to a further page listing applications/matters which include the forward citations for patent 802.

In an embodiment, the time period and category of forward citations is configurable by the user through one or more user interface elements (not shown) allowing the user to see a particular category of citations for the list of watched patents for a shorter or longer period. For example, the user may click on link 806 and a dialog box may be presented requesting the user enter a time period in days, weeks, or years. A list of the types of forward citations may be presented to the user with check-boxes for each type allowing the user to select one or more type of forward citation. Upon processing the user entered information, the system may format a query and submit the query to the watch database. The result of the query may include the number of forward citations for the specified category(s) during the time period for each matter the user has indicated to watch.

In an embodiment, the system processes the formatted query by iterating through the following operations for each matter the user has indicated to watch. Initially, the entry in the watch database is retrieved for the watched matter. The watch entry may include one or more forward citation entries. As discussed, a forward citation includes the date of publication of an application or issue date and a category of the forward citation. Consequently, forward citations of a watch database entry may be filtered by date and category according to the preferences entered by the user. For example, if the user entered a preference to see the past week's forward citations for all categories, the system may determine the number of forward citations with dates between the current date and the date one-week prior. Upon determining the number, the system may return the number for display to the user on the summary page.

In various embodiments, the user may click on link 808 to be taken to a listing of the applications/patents which include the forward citations for the watched application/patent. Details shown in list may include column headings of the application/patent number, title, owning entity, date, category of the citation, etc. These details may be retrieved by submitting a query to one or more databases in the manner discussed with respect to retrieving the number of forward citations. In an embodiment, the results of the query include the details of the forward citations. In various embodiments, the user may sort the list by the column headings. In an embodiment, a user preference allows the user to filter out forward citations that are owned by the same company as the watched matter.

In an embodiment, the initial time period and category of forward citations illustrated in FIG. 8 is dynamically chosen by the system based on the number of forward citations available for the various categories over a variety of time periods. For example, if only one forward citation (across all watched matters) is categorized as a direct citation, the system may expand the total of forward citations to include forward citations of prior art. In an embodiment, an importance hierarchy is defined, in descending order of importance: (1) forward citations of the patent being watched; (2) forward citations of applied prior art only; (3) forward citations of prior art; (4) forward citations of forward citations; and (5) forward citations of forward citations of cited art. If the total forward citations for the watched matters is not above a defined threshold (e.g., as set by a user or administrator), the system may move to through the hierarchy until the threshold is reached. In an embodiment, the time period is adjusted to reach the threshold. In various embodiments, the listing of forward citations presented upon activating link 808 are similarly dynamically adjusted based on a threshold number of forward citations.

Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

Example Machine Architecture and Machine-Readable Medium

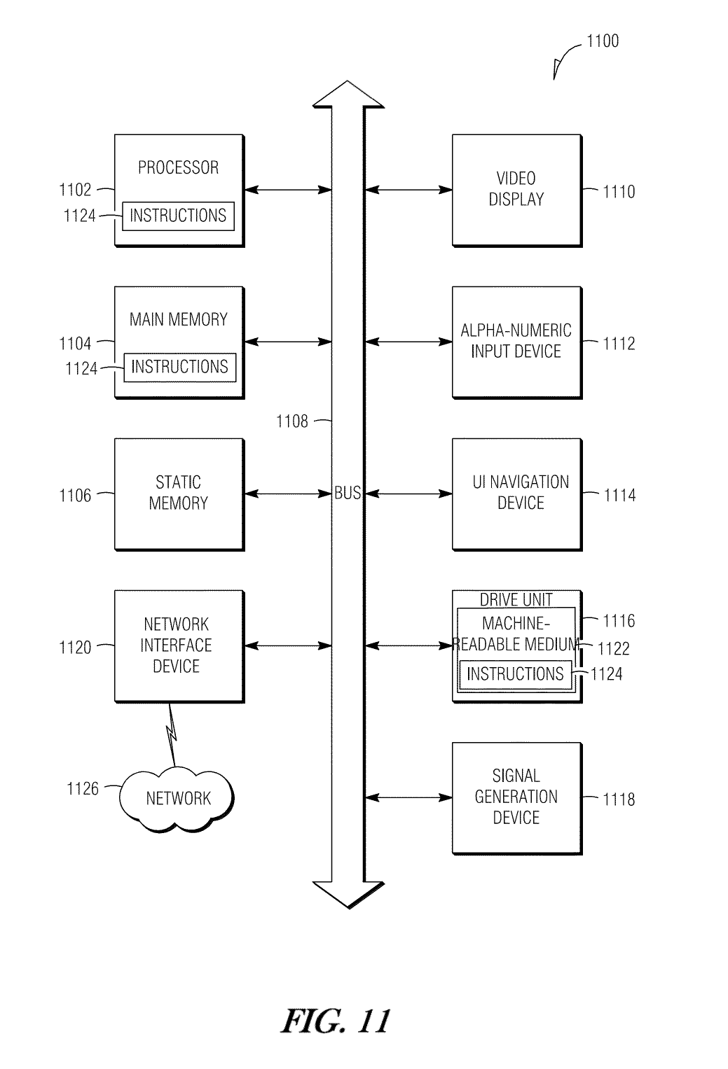

FIG. 11 is a block diagram of machine in the example form of a computer system 1100 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

Machine-Readable Medium

The disk drive unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
storing in a database, a plurality of patent entries, wherein a patent entry of the plurality of patent entries includes data fields for a payment due date and a payment amount associated with a fee due;
associating a primary contact and at least one secondary contact with the patent;
receiving contact information for the primary contact and contact information for the at least one secondary contact;
determining if the primary contact is available by periodically contacting the primary contact using the contact information for the primary contact before the payment due date; and
when it is determined the primary contact is not available:
contacting a secondary contact of the at least one secondary contact to retrieve updated contact information for the primary contact; and
when it is determined the primary contact is available:
storing an indication in the database that the contact information for the primary contact is up-to-date.

2. The method of claim 1, wherein the fee due is a maintenance fee or annuity payment for the patent.

3. The method of claim I, wherein the contact information for the primary contact includes a plurality of contact methods, the plurality of contact arranged in a hierarchical manner.

4. The method of claim 3, wherein contacting the primary contact using the contact information of the primary contact comprises:
attempting to contact the primary contact using a first contact method of the plurality of contact methods; and
when it is determined that the attempt was unsuccessful, attempting to contact the primary using a second method of the plurality of contact methods.

5. The method of claim 1, wherein the contact information of the primary contact includes a social network account.

6. The method of claim 5, further comprising:
determining that the primary contact is unavailable when the social network account has not been updated for a period of time.

7. The method of claim 1, further comprising:
contacting the primary contact on the payment due date that the fee is due.

8. A non-transitory computer-readable medium including instructions which when executed by at least one process configure the at least one processor to perform a method comprising:
storing in a database, a plurality of patent entries, wherein a patent entry of the plurality of patent entries includes data fields for a payment due date and a payment amount associated with a fee due;
associating a primary contact and at least one secondary contact with the patent;
receiving contact information for the primary contact and contact information for the at least one secondary contact;
determining if the primary contact is available by periodically contacting the primary contact using the contact information for the primary contact before the payment due date; and
when it is determined the primary contact is not available:
contacting a secondary contact of the at least one secondary contact to retrieve updated contact information for the primary contact; and
when it is determined the primary contact is available:
storing an indication in the database that the contact information for the primary contact is up-to-date.

9. The computer-readable medium of claim 8, wherein the fee due is a maintenance fee or annuity payment for the patent.

10. The computer-readable medium of claim 8, wherein the contact information for the primary contact includes a plurality of contact methods, the plurality of contact arranged in a hierarchical manner.

11. The computer-readable medium of claim 10, wherein contacting the primary contact using the contact information of the primary contact comprises:
attempting to contact the primary contact using a first contact method of the plurality of contact methods; and
when it is determined that the attempt was unsuccessful, attempting to contact the primary using a second method of the plurality of contact methods.

12. The computer-readable medium of claim 8, wherein the contact information of the primary contact includes a social network account.

13. The computer-readable medium of claim 12, further comprising:
determining that the primary contact is unavailable when the social network account has not been updated for a period of time.

14. The computer-readable medium of claim 8, further comprising:
contacting the primary contact on the payment due date that the fee is due.

15. A system comprising:
a database;
at least one processor;
a non-transitory computer-readable medium with instructions stored thereon, wherein when the instructions are executed by the at least one processor the at least one processor is configured to:
store in the database, a plurality of patent entries, wherein a patent entry of the plurality of patent entries includes data fields for a payment due date and a payment amount associated with a fee due;
associate a primary contact and at least one secondary contact with the patent;
receive contact information for the primary contact and contact information for the at least one secondary contact;
determine if the primary contact is available by periodically contacting the primary contact using the contact information for the primary contact before the payment due date; and
when it is determined the primary contact is not available:
contact a secondary contact of the at least one secondary contact to retrieve updated contact information for the primary contact; and
when it is determined the primary contact is available:
store an indication in the database that the contact information for the primary contact is up-to-date.

16. The system of claim 9, wherein the fee due is a maintenance fee or annuity payment for the patent.

17. The system of claim 9, wherein the contact information for the primary contact includes a plurality of contact methods, the plurality of contact arranged in a hierarchical manner.

18. The system of claim 17, wherein configuring the at least one processor to contact the primary contact using the contact information of the primary contact comprises configuring the at least one processor to:
attempt to contact the primary contact using a first contact method of the plurality of contact methods; and
when it is determined that the attempt was unsuccessful, attempt to contact the primary using a second method of the plurality of contact methods.

19. The system of claim 15, wherein the contact information of the primary contact includes a social network account.

20. The system of claim 19, further configuring the at least one processor to determine that the primary contact is unavailable when the social network account has not been updated for a period of time.
